(19) United States
(12) Patent Application Publication
(10) Pub. No.: US 2003/0036811 A1
(43) Pub. Date: Feb. 20, 2003

(54) Operating system and method for updating a software functional interface at any time

(76) Inventors: Kuang-Shin Lin, Taipei (TW); Sayling Wen, Taipei (TW); Gui-Long Guo, Tianjin (CN)

Correspondence Address: BIRCH STEWART KOLASCH & BIRCH, PO BOX 747, FALLS CHURCH, VA, 22040-0747, US

(21) Appl. No.: 10/216,223

(22) Filed: Aug. 12, 2002

(30) Foreign Application Priority Data
Aug. 14, 2001 (TW) 90119848

(51) Int. Cl. G05B 11/01; G05B 19/42

(52) U.S. Cl. 700/18; 700/86; 700/87; 700/88

(57) ABSTRACT

An OS for updating a software functional interface at any time and the method for the same. The invention is applied to a one-touch OS over a computer executable hardware platform. It allows a user to update the software functional interface at any time for function upgrades. According to the increase in the user's computer knowledge, the user can selectively upgrade the OS to expand and extend a simple OS, achieving the goal of educating the user on computer concepts step by step.

### BACKGROUND OF THE INVENTION

1. Field of the Invention

The invention relates to a system and method of upgrading an OS and, in particular, to an OS and method that can update a software functional interface at any time.

2. Related Art

Although existing PC (Personal Computer) OS's (Operating Systems), such as MS Windows or Linux, have many good designs and functions, they are still quite complicated to use. One drawback is that the user operating interface is not intuitive and simple enough. For users without any computer background, such system can be quite daunting.

In this situation, users often select a more familiar OS or install several different OS's on a computer hardware platform, and switch between them. This kind of system with two coexisting OS's is called a dual-OS. However, even the dual-OS cannot solve the above-mentioned problems. Therefore, one needs a simple and convenient OS.

The one-touch OS with a simple and intuitive UOI (User Operating Interface) has thus been invented. This OS utilizes a finite number of keys as hot keys for operations of various functions so that the functions can be initiated by pressing a single key. This makes computer operation more intuitive.

However, the design of the one-touch OS is intended for novice users. The whole application unit provides the most basic functions. As the user learns more about computers, the basic functions may not be able to satisfy the user's actual needs. Consequently, allowing the user to update the software functional interface of the one-touch OS on a computer executable hardware platform according to his or her needs at any time is an urgent need in the industry

### SUMMARY OF THE INVENTION

An objective of the invention is to make a simple OS become more sophisticated according to the increase of a user's computer knowledge resulting from his or her repeated use of the one-touch OS over a computer executable hardware platform, achieving the goal of improving the user's understanding of the computer step by step.

The invention discloses an OS that can update a software functional interface at any time. The OS includes at least: an application unit function module database, which stores at least one application unit updating program to be expanded; an application unit upgrade module, which organizes connections of the application unit updating programs; a knowledge upgrade management module, which links the application unit function module database and the application unit upgrade module, determines and calls the corresponding application unit updating program, thereby updating the application unit upgrade module; an upgrade selection interface, which allows a user to select a function module to be updated; and an interactive management module, which links the upgrade selection interface and the knowledge upgrade management module as commands are provided by the user to the OS.

The invention also proposes a method that can update a software functional interface of an OS at any time. This method applies to a one-touch OS running over a computer executable hardware platform. It includes the steps of: displaying an upgrade module list of all application units; selecting an upgrade module of the application unit to be upgraded; locating the upgrade module of the application unit to be upgraded; selecting an installation method for upgrading; and installing the upgrade module of the application unit to be upgraded to the OS.

### BRIEF DESCRIPTION OF THE DRAWINGS

The present invention will become more fully understood from the detailed description given hereinbelow illustration only, and thus are not limitative of the present invention, and wherein:

FIG. 1 is a system block diagram of the invention;

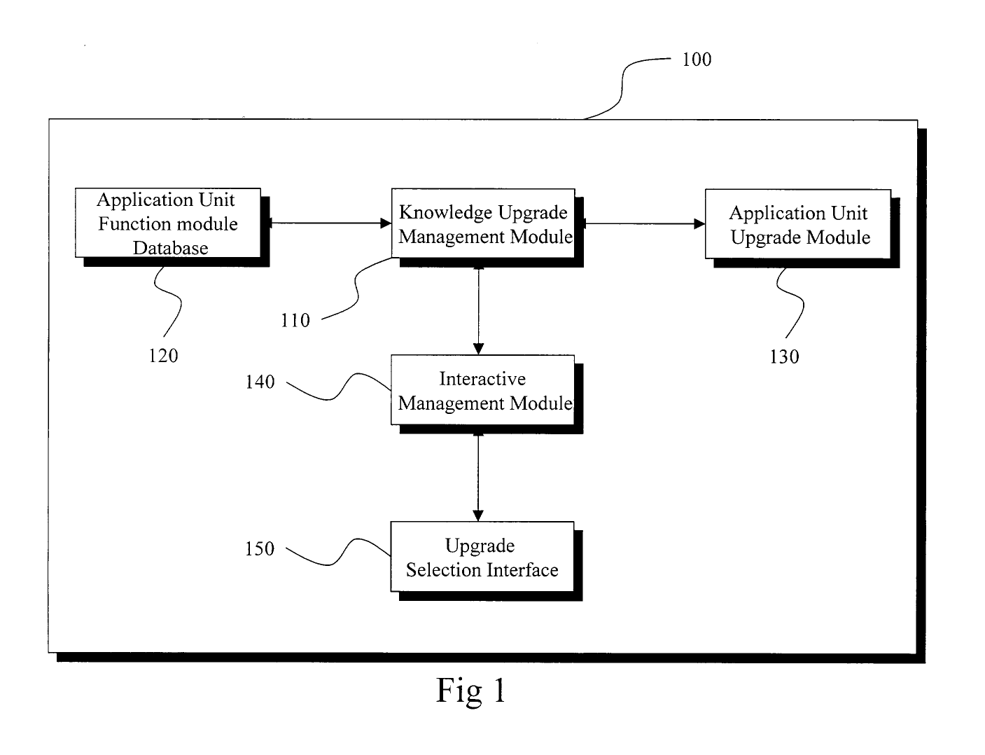

FIG. 2 is a schematic view of the application unit module in FIG. 1;

FIG. 3 is a flowchart of the disclosed method; and

FIG. 4 is a schematic view of the disclosed knowledge upgrade interface.

### DETAILED DESCRIPTION OF THE INVENTION

The invention proposes an OS (Operating System) and method that can update a software functional interface at any time. The invention is used in a one-touch OS running over a computer executable hardware platform. Through the disclosed upgrade system 100, the originally simple and intuitive OS can be upgraded selectively according to the user's needs and familiarity with computer technology. The upgrade system 100 includes at least a knowledge upgrade management module 110, an application unit function module database 120, an application unit upgrade module 130, an interactive management module 140, and an upgrade selection interface 150.

The user sends the upgrade message to the interactive management module 140 through the upgrade selection interface 150. The interactive management module 140 then sends the request to the knowledge upgrade management module 110, which makes a decision to send the data that the user requests to the interactive management module 140. Finally, the upgrade process is performed according to the user's request.

The disclosed application unit function module database 120 stores at least one update program for an application unit to be expanded. The application unit upgrade module 130 organizes the relations among the update programs for the application units. The knowledge upgrade management module 110 links the application unit function module database 120 and the application unit upgrade module 130, determining and calling the corresponding application unit update program for updating the application unit upgrade module. The invention provides the upgrade selection interface 150 for the user to selectively choose a function module to be updated. Then the interactive management module 140 links the upgrade selection interface 150 and the knowledge upgrade management module 110 (as a communication between the user and the OS.)

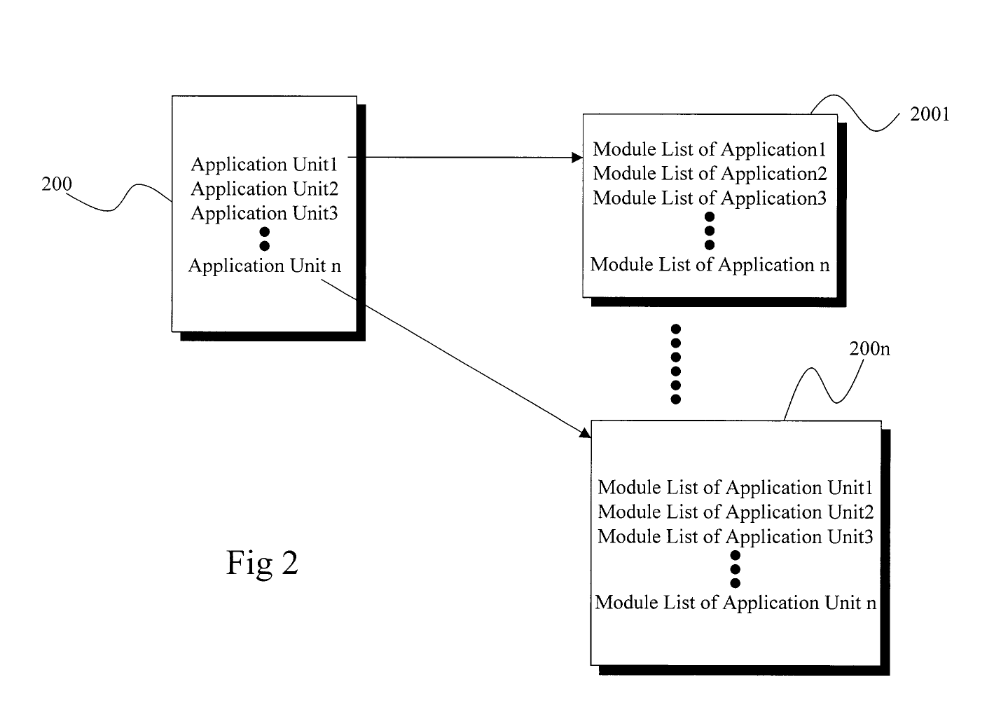

As shown in FIG. 2, when the user wants to update the functions in the original OS, the corresponding function module data structure has to be verified. For example, the application unit 1, the application unit 2, . . . the application unit n in the application unit 200 have to be linked to the module list 2001 of the application unit 1, . . . the module list 200n of the application unit n according to an index. When the user makes an upgrade request, data in all modules are called for performing the upgrade.

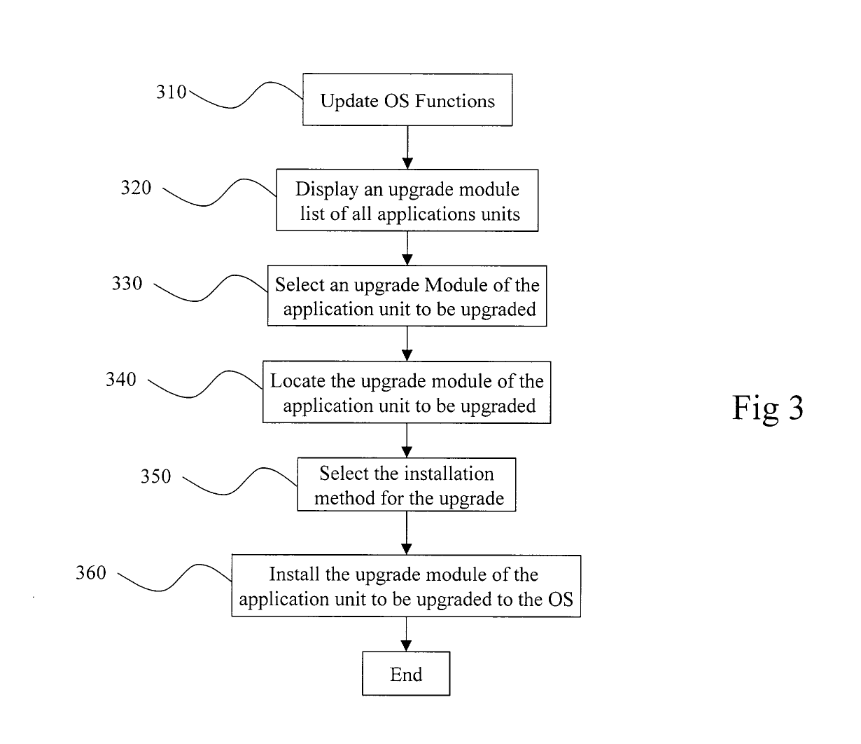

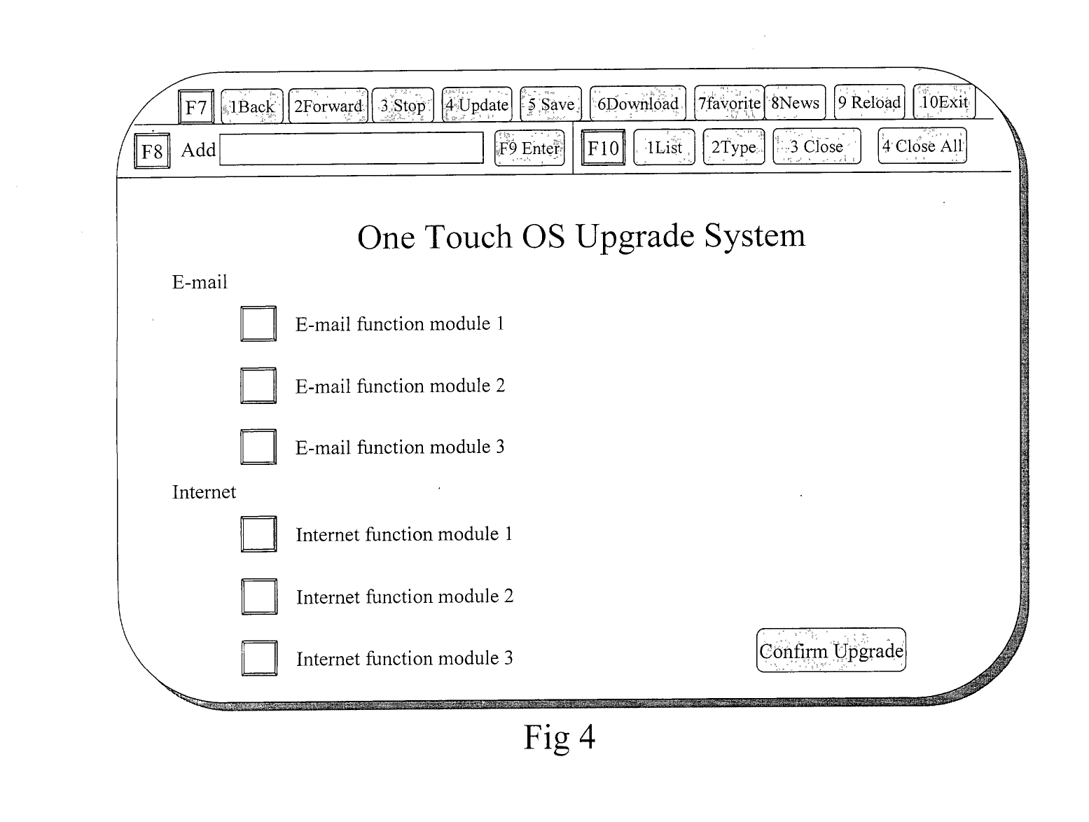

With reference to FIG. 3, the disclosed method starts by updating the functions of the OS (step 310). This step opens an update software function interface (see FIG. 4 for a schematic view of the knowledge upgrade interface). The update software function interface displays the upgrade module lists of all application units (step 320). Afterwards, the upgrade module of the application unit to be upgraded is selected (step 330). The upgrade module for the application unit is also located (step 340). The update system 100 further provides selections of installation methods for the upgrade (step 350). One can select whether to update from a distant server (through a network), to download the upgrade program to a local machine to update, or to update the software through a disk drive. Finally, the upgrade module of the application unit to be upgraded is installed into the OS (step 360), completing the update procedure.

Now we take an actual case to explain the upgrade advantage and the implementation method of the invention. The main functions of E-mail services in a one-touch OS are to browse and edit electronic messages, and to attach files. These are the most basic functions of the E-mail services. of the E-mail services.

If the user becomes interested in extra functions in the E-mail services or wants to have more functions available, he or she can selectively choose the application units to be expanded . Taking the current embodiment as an example, there is at least one selective expansion choice, including E-mail function module 1, E-mail function module 2, and E-mail function module 3. There are advanced selective updates, such as spelling check, security settings, signature, receipt confirmation, interface layout, encryption, etc. These new function modules are stored in the application unit function module database 120 for the user to selectively choose and add to any E-mail function module. The selected function module is requested and selected through the upgrade selection interface 150. Through the determination of the upgrade management module 110, the corresponding function module is called to perform the update action on the application unit upgrade module 130. Meanwhile, all computer actions are executed by the interactive management module 140.

Other functions of the one-touch OS, such as networking, faxing, electronic album, word processing, multimedia playing, games and language learning, can be selectively updated in a similar way.

Advantages of the Invention

Through the disclosed system and method, not only are computers simple and intuitive for users to operate , software functional interfaces can be updated at any time according to the user's needs to expand the functions. The system can be upgraded according to the user's increasing computer knowledge, thus extending the lifetime of the one-touch OS. The user can selectively upgrade the OS to expand from a simple OS to a sophisticated one, achieving the goal of educating the user on computer concepts step by step.

What is claimed is:

1. An OS (Operating System) running in a one-touch system over a computer executable hardware platform for updating a software functional interface at any time, comprising:
an application unit function module database, which stores at least one update program for an application unit to be expanded;
an application unit upgrade module, which associates the update programs to the application units;
a knowledge upgrade management module, which links the application unit function module database to the application unit upgrade module, determines and calls the update program corresponding to an application unit to update the application unit upgrade module;
an upgrade selection interface, which allows a user to selectively choose the function module to be updated; and
an interactive management module, which links the upgrade selection interface and the knowledge upgrade module, forming communications between the user and the OS.

2. The OS of claim 1, wherein the one-touch system is a work group which completes a particular job displayed by an interface generating module according to a single action performed by the user.

3. The OS of claim 2, wherein the work group consists of at least one function.

4. The OS of claim 2, wherein the single action is an action the user performs on a basic I/O (Input/Output) device control provided by the computer executable hardware platform according to a hint menu generated by the interface generating module.

5. The OS of claim 4, wherein the basic I/O device is selected from the group consisting of a keyboard, a mouse, a digital touch-control panel, and a voice recognition system.

6. The OS of claim 1, wherein the one-touch system coexists with other different systems and the user can switch among the systems.

7. The OS of claim 1, wherein the upgrade selection interface provides a function selected from the group consisting of E-mail, network, fax, electronic album, word processing, multimedia playing, games, and language learning.

8. The OS of claim 1, wherein the updating method is selected from the group consisting of updating from a distant server, downloading and then updating, and updating from a disk drive.

9. A method for updating applied in a one-touch system over a computer executable hardware platform for updating a software functional interface of an OS at any time, which comprises the steps of:
displaying upgrade module lists of all application units;
selecting the upgrade module of the application unit to be upgraded;
locating the upgrade module of the application unit to be upgraded;
selecting an installation method for the upgrading; and
installing the upgrade module of the application unit to be upgraded into the OS.

10. The method of claim 9, wherein the one-touch system is a work group which completes a particular job displayed by an interface generating module according to a single action performed by the user.

11. The method of claim 10, wherein the work group consists of at least one function.

12. The method of claim 10, wherein the single action is an action the user performs on a basic I/O (Input/Output) device control provided by the computer executable hardware platform according to a hint menu generated by the interface generating module.

13. The method of claim 12, wherein the basic I/O device is selected from the group consisting of a keyboard, a mouse, a digital touch-control panel, and a voice recognition system.

14. The method of claim 9, wherein the one-touch system coexists with other different systems and the user can switch among the systems.

15. The method claim 9, wherein the upgrade selection interface provides a function selected from the group consisting of E-mail, network, fax, electronic album, word processing, multimedia playing, games, and language learning.

16. The method of claim 9, wherein the updating method is selected from the group consisting of updating from a distant server, downloading and then updating, and updating from a disk drive.
